(19) United States
(12) Patent Application Publication
(10) Pub. No.: US 2024/0286803 A1
(43) Pub. Date: Aug. 29, 2024

(54) QUICK UNCAPPING STRUCTURE AND CONTAINER

(71) Applicant: JINHUA HUALIANG VESSEL CO., LTD, Jinhua (CN)

(72) Inventors: Xinghua Zhu, Jinhua (CN); Liqun Dai, Jinhua (CN)

(21) Appl. No.: 18/195,358

(22) Filed: May 9, 2023

Related U.S. Application Data
(63) Continuation of application No. PCT/CN2023/084282, filed on Mar. 28, 2023.

(30) Foreign Application Priority Data
Feb. 28, 2023 (CN) 202310214367.2

(51) Int. Cl. B65D 45/02; B65D 41/02; B65D 41/28; B65D 55/16

(52) U.S. Cl. CPC B65D 45/02; B65D 41/023; B65D 41/28; B65D 55/16

(57) ABSTRACT

A cover body of a quick uncapping structure comprises a cover, an elastic sealing ring, a guide rod comprising a supporting bottom plate and a vertical rod, and a lever, wherein a vertical rod arranged in the cover penetrates through a center hole of the cover to be rotationally connected with the external lever; the bottom face of the elastic sealing ring that is sleeved on the guide rod is in contact with the supporting bottom plate; the cover covers a drinking opening of a main body, the elastic sealing ring and the guide rod stretch into the drinking opening, the lever drives the guide rod to move upwards when being rotated to a locking state, and the elastic sealing ring is extruded to deform to make contact with the inner wall of the drinking opening for sealing.

### CROSS REFERENCE TO RELATED APPLICATIONS

The present application is a Continuation application of PCT Application No. PCT/CN2023/084282 filed on Mar. 28, 2023, which claims the benefit of Chinese Patent Application No. 202310214367.2 filed on Feb. 28, 2023. All the above are hereby incorporated by reference in their entirety.

### FIELD OF THE INVENTION

The present invention belongs to the technical field of daily necessities, and particularly relates to a quick uncapping structure and a container.

### BACKGROUND OF THE INVENTION

At present, most of water containers for heat preservation, cold preservation or normal temperature, such as water cups, kettles, bottles, etc, contain a main body for accommodating liquid and a cover for opening or closing the drinking opening of the main body. Most of the covers adopt a threaded design, which matches with thread of the drinking opening to complete the sealing.

For this conventional opening method of threaded covers, users need to rotate the covers during the thread opening process, so the uncapping is slow. After re-rotating and closing, the seal depends on the matching between the cup cover and two threads on the cup body; if the rotation is not appropriate or the rotation angle deviates, the reliability is poor and water leakage may be caused, thus the convenience of use is poor.

In addition, a part of the cup cover is designed as a flip cover. The cup cover is installed on the cup. When the flip cover is opened and the cup is tilted to drink water, the flip cover will touch the nose partially, and the water on the cover is small; compared with drinking water without a cover, the water outflow speed is slow, which is inconvenient to use and not conducive to fast drinking.

### SUMMARY OF THE INVENTION

An object of the present invention is to provide a quick uncapping structure and a container to solve the defects in the prior art. The quick uncapping structure has good sealing performance; a lever can be simply rotated to realize uncapping, making opening and closing to be convenient and rapid; a problem that the nose is possibly touched locally when a cover is removed wholly for drinking is solved and a bottle can be uncovered rapidly for smooth drinking.

In order to achieve the above object, the present invention adopts the following technical solutions: a quick uncapping structure comprises a cover body; the cover body comprises a cover, an elastic sealing ring, a guide rod and a lever; the guide rod comprises a supporting bottom plate and a vertical rod; the guide rod is arranged in the cover, and the vertical rod of the guide rod penetrates through a center hole of the cover to be rotationally connected with the external lever; the guide rod is sleeved with the elastic sealing ring, and the bottom face of the clastic sealing ring makes contact with the supporting bottom plate;
the cover covers a drinking opening of a main body accommodating liquid; the elastic sealing ring and the guide rod stretch into the drinking opening; the lever drives the guide rod to move upwards when being rotated to a locking state; and the clastic sealing ring is extruded to deform to make contact with the inner wall of the drinking opening to be in a sealed state.

In the process that the lever is rotated to the locking state, the vertical rod is driven to move upwards, the elastic sealing ring located above the supporting bottom plate is pulled to move upwards till the upper end abuts against the inner surface of the cover, and then the elastic scaling ring continues to move upwards to deform to transversely extrude the inner wall of the drinking opening, thus realizing scaling.

Further, a concave elastomer deformation accommodating area is arranged on the inner wall of the drinking opening; and when the lever is rotated to the locking state, the guide rod is driven to move upwards to compress the clastic sealing ring to enter the elastomer deformation accommodating area to be in a sealed state.

Further, the outer wall of the elastic sealing ring is an arc-shaped face or a straight face.

Further, the quick uncapping structure further comprises an annular guide piece arranged in the cover; the vertical rod is sleeved with the annular guide piece; the upper end of the annular guide piece makes contact with the inner top face of the cover, and the lower end of the annular guide piece is assembled with the upper end of the elastic scaling ring. In the process that the lever is rotated to the locking state, the vertical rod is driven to move upwards, the elastic scaling ring located above the supporting bottom plate is pulled, the annular guide piece moves upwards till the upper end of the annular guide piece abuts against the inner surface of the cover, then the annular guide piece continues to move upwards to deform the elastic sealing ring so as to transversely extrude the inner wall of the drinking opening, thus sealing is realized.

Still further, at least one first limiting part is arranged on the lower end face of the annular guide piece; at least one second limiting part is arranged on the upper end face of the elastic sealing ring; and the first limiting part is matched with the second limiting part.

Still further, a cover guide-in section is arranged on the outer side wall of the annular guide piece and is in clearance fit with an opening guide-in section on the inner wall of the drinking opening, and thus shaking of the annular guide piece and the elastic sealing ring on the lower side in the process of assembling the annular guide piece and the elastic sealing ring in the drinking opening is reduced.

Still further, an annular protruding part is arranged on the inner wall of the drinking opening, and the opening guide-in section is arranged on the annular protruding part.

The present invention further provides a container. The container comprises the quick uncapping structure and a main body for accommodating liquid.

Further, a boss is arranged on the outer wall of the lower end of the drinking opening, and the lower end face of the cover makes contact with the boss in a propping abutting mode when the drinking opening is covered with the cover.

Further, the container further comprises a connecting belt; the two ends of the connecting belt are connected to the outer wall of the main body and the outer wall of the cover respectively, thus the cover can be directly hung and stored conveniently after being opened, and the cover is not prone to being lost when not placed independently.

By the adoption of the technical solutions, the present invention has the following beneficial effects:
1. The elastic sealing ring, the guide rod and the lever are cooperated, the elastic sealing ring is compressed to deform and elastically recovered; the drinking opening is jacked through transverse compression deformation, and thus internal sealing of the drinking opening is achieved; and the cover is directly taken and the drinking opening is opened for drinking by elastic recovering, so that the sealing performance of the main body for accommodating the liquid and the cover body is more reliable;
2. In the using process, the lever is simply pressed, the lever does not need to be rotated by a plurality of turns through threads, the cover can be opened and closed quickly and conveniently, thus the convenience of drinking water is improved, and the bottle can be rapidly uncovered for smooth drinking;
3. The inner wall of the cover and the outer wall of the drinking opening are both smooth faces without threads; compared with a traditional uneven threaded face, bacteria are not prone to being adsorbed on the smooth face, thus the cleanliness degree of the drinking opening is higher, and the sanitation degree of drinking is improved; and
4. The cover of the quick uncapping structure can be directly placed at the drinking opening, the cover is quickly removed from the main body through the lever, water can be greatly drunk from the drinking opening of the main body, and smooth drinking can be achieved.

### BRIEF DESCRIPTION OF THE DRAWINGS

FIG. 1a is a cross-sectional view of a container with a quick uncapping structure in an open state in Example 1;

FIG. 1b is a cross-sectional view of a container with a quick uncapping structure in a locked state in Example 1;

FIG. 1c is a partial enlarged view of a quick uncapping structure in Example 1;

FIG. 1d is a three-dimensional state diagram of Example 1;

FIG. 2a is a cross-sectional view of a container with a quick uncapping structure in an open state in Example 2;

FIG. 2b is a cross-sectional view of a container with a quick uncapping structure in a locked state in Example 2;

FIG. 2c is a three-dimensional state diagram of Example 2;

FIG. 3a is a schematic diagram of another guide rod;

FIG. 3b is a front view of another guide rod;

FIG. 4 is an assembly structure diagram of an elastic sealing ring and an annular guide piece.

### REFERENCE NUMERALS

1, main body; 11, boss; 12, drinking opening; 121, annular flange; 2, cover; 201, first circular ring; 202, accommodating groove; 203, clamping groove; 21, elastic sealing ring; 211, annular protruding part; 22, annular guide piece; 221, annular assembling groove; 23, guide rod; 231, supporting bottom plate; 232, vertical rod; 232a, guide bar; 232b, through hole; 233, connecting screw; 24, lever; 241, connecting part; 242, pressing part; 243, protruding part; 25, groove; 251, clamping groove; 252, accommodating groove; 3, elastomer deformation accommodating area; 4, connecting belt; 5, pin shaft; 6, gasket; 61, gap.

### DETAILED DESCRIPTION

The specific solutions and specific embodiments of the present invention are further described in conjunction with the accompanying drawings, to make the technical solutions clearer.

### Example 1

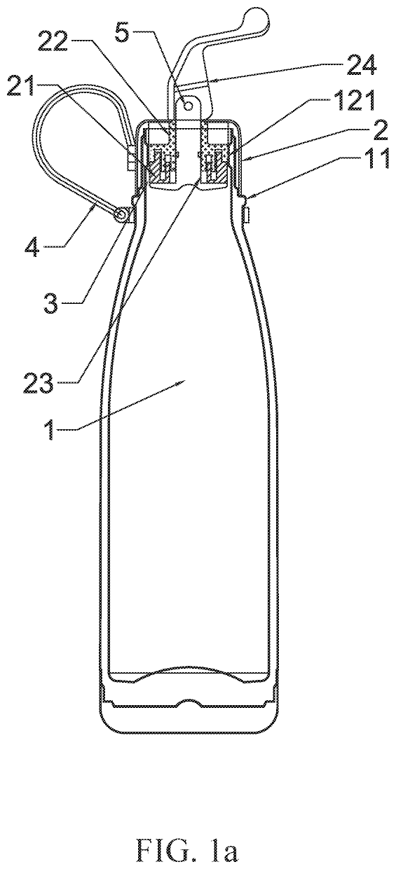

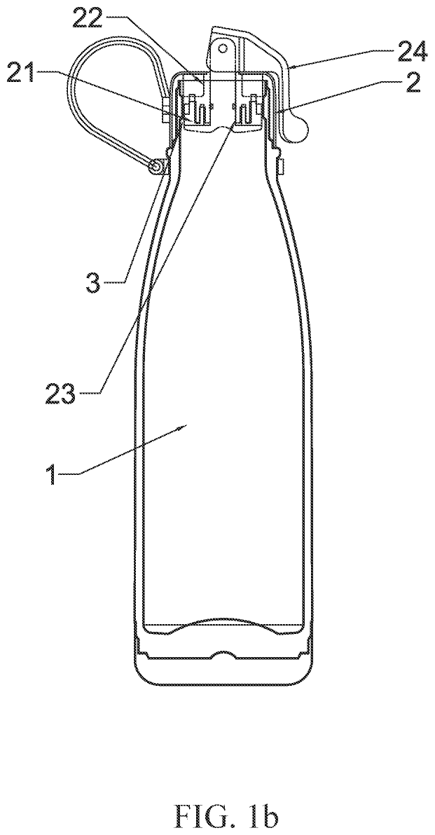

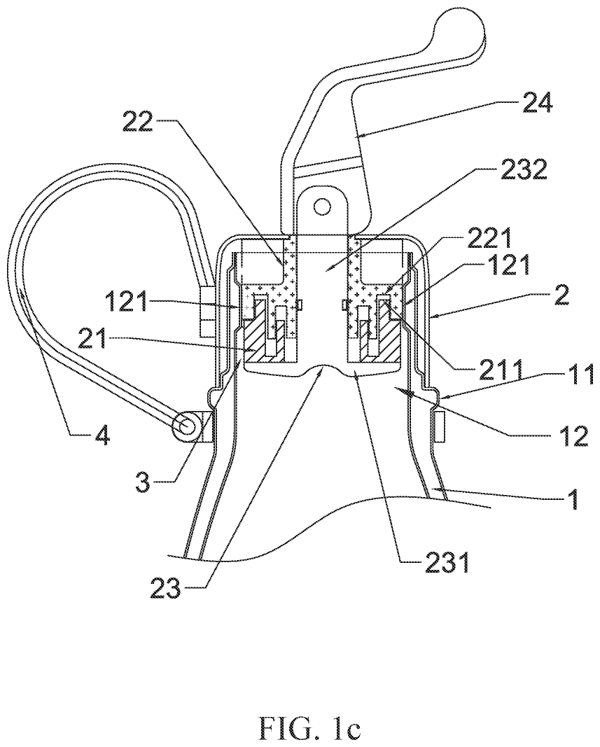

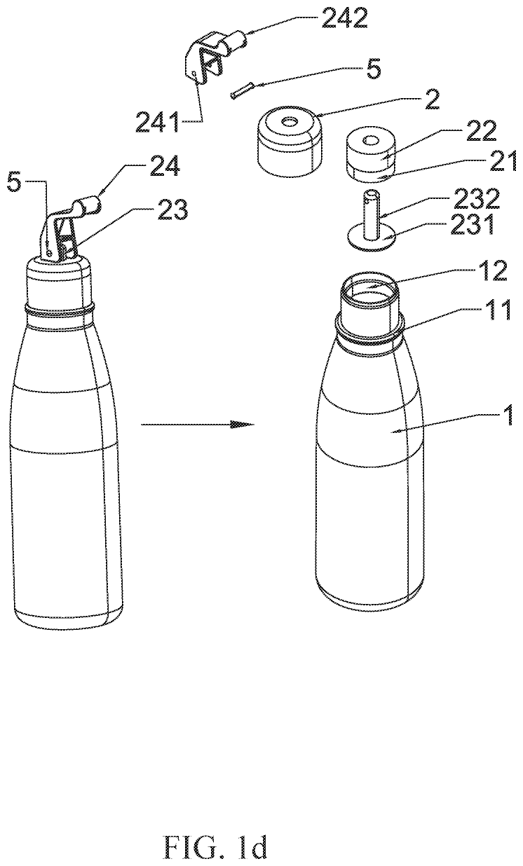

As shown in FIG. 1a-1d, this example discloses a quick uncapping structure, comprising a cover body; the cover body comprises a cover 2, an elastic sealing ring 21, an annular guide piece 22, a guide rod 23 and a lever 24. The guide rod 23 comprises a supporting bottom plate 231 and a vertical rod 232; the vertical rod 232 penetrates through a center hole of the cover 2 to be rotationally connected with the external lever 24 of the cover 2; the annular guide piece 22 is sleeved on the vertical rod 232 and the upper end is in contact with the top surface of the cover 2; the elastic sealing ring 21 is sleeved on the vertical rod 232 and the upper end is in contact with the lower end of the annular guide piece 22, the bottom surface of the elastic sealing ring 21 is in contact with the supporting bottom plate 231;

The inner wall of a cover 2 makes contact with the outer wall of a drinking opening 12 of a main body 1 for accommodating liquid; the inner wall of the drinking opening 12 is provided with a concave elastomer deformation accommodating area 3; the elastomer deformation accommodating area 3 is annular and is used for accommodating an annular elastic sealing ring 21; and when a lever 24 is rotated to a locking state, a guide rod 23 is driven to move upwards to compress the elastic sealing ring 21 to deform and enter the elastomer deformation accommodating area 3 to be in a sealed state.

In a first example, the elastic sealing ring 21 and an annular guide piece 22 are in a conventional cylindrical shape, and holes are formed in the middle parts of the elastic sealing ring and the annular guide piece and used for installing a vertical rod 232.

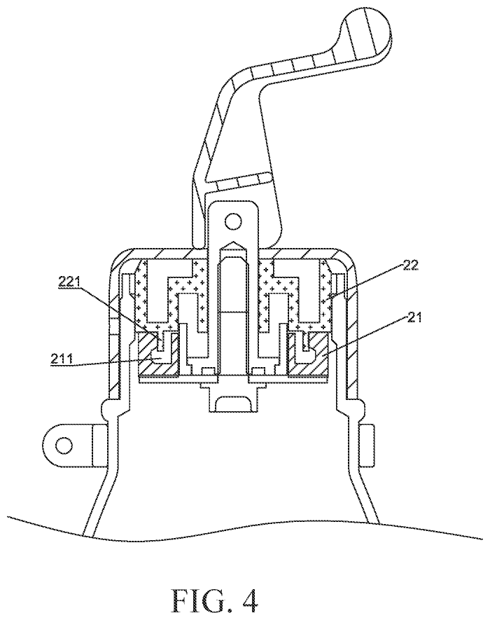

In a second example, a first limiting part 221 is arranged on the lower end face of the annular guide piece 22; a second limiting part 211 is arranged on the upper end face of the elastic scaling ring 21; and when the elastic sealing ring 21 and the annular guide piece 22 are sleeved on the vertical rod 232 after the holes are formed in the middle parts, the first limiting part 221 and the second limiting part 211 are matched to limit movement between the elastic sealing ring 21 and the annular guide piece 22. As shown in FIGS. 1a-1c, the first limiting part 221 adopts a single convex block (or a circular convex ring), the second limiting part 211 adopts a single groove (or a circular groove), and the convex block (or the circular convex ring) is embedded in the groove (or circular groove) to realize limiting between the elastic sealing ring 21 and the annular guide piece 22. Or as shown in FIG. 4, the first limiting part 221 adopts a single groove (or a circular groove), the second limiting part 211 adopts a single convex block (or a circular convex ring), and the single convex block (or the circular convex ring) is embedded in the single groove (or the circular groove) to realize limiting between the elastic sealing ring 21 and the annular guide piece 22.

The matched grooves and convex blocks can be set as single or multiple distributed along the peripheries of the upper and lower end faces; and the matched circular grooves and circular convex rings can be set as single circles or multiple circles concentrically distributed along the peripheries of the upper and lower end faces.

In this example, a through hole is formed in the top of the vertical rod 232, and a pin shaft 5 penetrates through the lever 24 and the through hole to complete assembling of the vertical rod 232 and the lever 24. The lever 24 in the example is in an L shape; a connecting part 241 at one end of the lever 24 is rotationally connected with the vertical rod 232 through the pin shaft 5; and by pressing a pressing part 242 at the other end, the lever 24 does not make contact with the cover 2 in the opening state as shown in FIG. 1a; and in the sealing state, the L-shaped lever 24 is rotated around the pin shaft 5 till the inner wall of the lever 24 is attached to the upper surface and the side wall of the cover 2 to reach the locking state. In the rotating process of the lever 24, the vertical rod 232 and a supporting bottom plate 231 are driven to move upwards, and then the annular guide piece 22 and the elastic sealing ring 21 are driven to move upwards; because the distance between the inner top face of the cover 2 and the supporting bottom plate 231 is continuously decreased, the annular guide piece 22 is made of hard materials and does not deform, the elastic sealing ring 21 has elasticity and is pressed to generate transverse deformation, the inner side and the outer side of the elastic sealing ring 21 transversely extrude the inner walls of the vertical rod 232 and the drinking opening 12, and finally an effective sealing state is formed.

The elastic sealing ring 21 is made of silica gel, rubber or various existing elastic plastic materials. When the lever 24 is opened and turned upwards, the whole lever 24 is tilted above the cover 2, the elastic sealing ring 21 is in an elastic recovering and releasing state and does not make contact with the inner wall of the drinking opening 12, and sealing is not realized, so that a cover body can be quickly opened. When the guide rod 23 is tensioned upwards through the lever 24, the elastic sealing ring 21 is in a compressed state, the materials such as the silica gel of the transversely-deformed elastic sealing ring are squeezed into the elastomer deformation accommodating area 3 to make contact with the inner wall of the drinking opening 12 in a jacking and abutting mode, and thus the sealing effect is achieved through deformation of the materials; and the lever is used for controlling the elastic sealing ring to be compressed and released to seal the main body or release sealing so that a purpose of quickly opening the cover body can be directly achieved.

In this example, the outer wall of the elastic sealing ring 21 is an arc-shaped face or a straight face.

The outer wall of the annular guide piece 22 is in clearance fit with the inner wall of the drinking opening 12, and the inner diameter of the drinking opening 12 is about 0.2-0.5 mm larger than the outer diameter of the annular guide piece 22. Specifically, an annular flange 121 is arranged on the inner wall of the drinking opening 12; and when the quick uncapping structure is assembled to the main body 1, the outer wall of the annular guide piece 22 is in clearance fit with the surface of the annular flange 121.

The example also provides a container, which comprises the quick uncapping structure and a main body 1 for accommodating liquid. The outer wall of the lower end of the drinking opening 12 is provided with a boss 11, and the lower end face of the cover 2 makes contact with the boss 11 in a jacking and abutting mode when the cover 2 covers the drinking opening 12.

In this example, the bottom of the main body 1 adopts a plane or a plane of which the center is arched upwards. The main body 1 can be of a single-layer or double-layer structure, and vacuum can be designed between the inner layer and the outer layer of the double-layer structure to be used as a vacuum cup.

In a specific example, the container also comprises a connecting belt 4, and two ends of the connecting belt 4 are connected to the outer wall of the main body 1 and the outer wall of the cover 2 respectively, particularly connected to the side wall (or the top) of the cover 2.

Preferably, a connecting part of the connecting belt 4 and the cover 2 is in the direction opposite to the rotating direction of the lever 24, and interference is not formed so as to facilitate use.

The main body 1 adopts the shapes of various conventional containers such as a bottle body, a tank body and a cup.

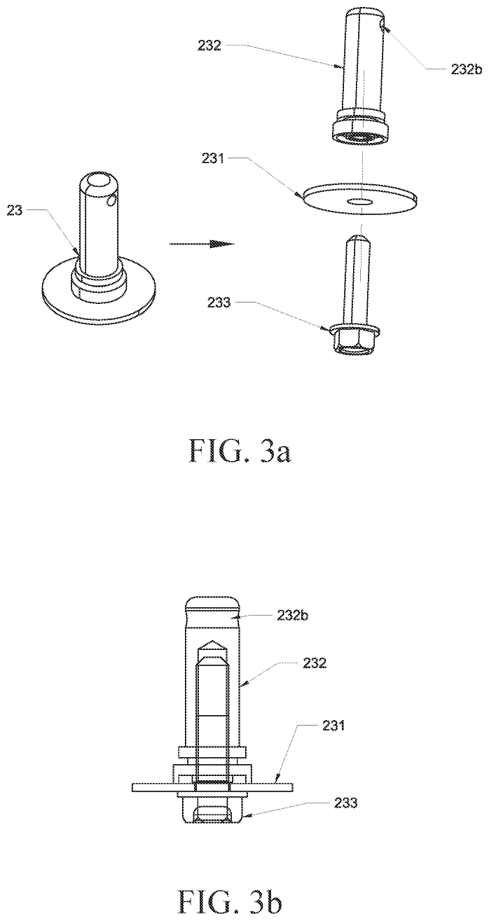

In this example, the guide rod can adopt a structure integrally formed by the abovementioned supporting bottom plate 231 and the vertical rod 232, and also can adopt an assembly structure shown in FIGS. 3a and 3b. As shown in FIG. 3a and FIG. 3b, the guide rod 23 comprises the supporting bottom plate 231, the vertical rod 232 and a connecting screw 233; and the connecting screw 233 passes through the lower part of the supporting bottom plate 231 and extends into a hole below the vertical rod 232 to be fixed. A through hole 232b in the top of the vertical rod 232 is used for mounting the pin shaft 5.

### Example 2

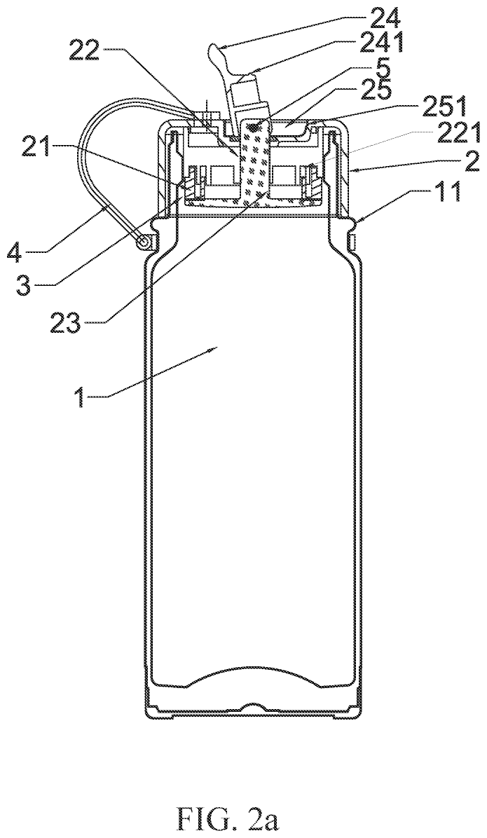

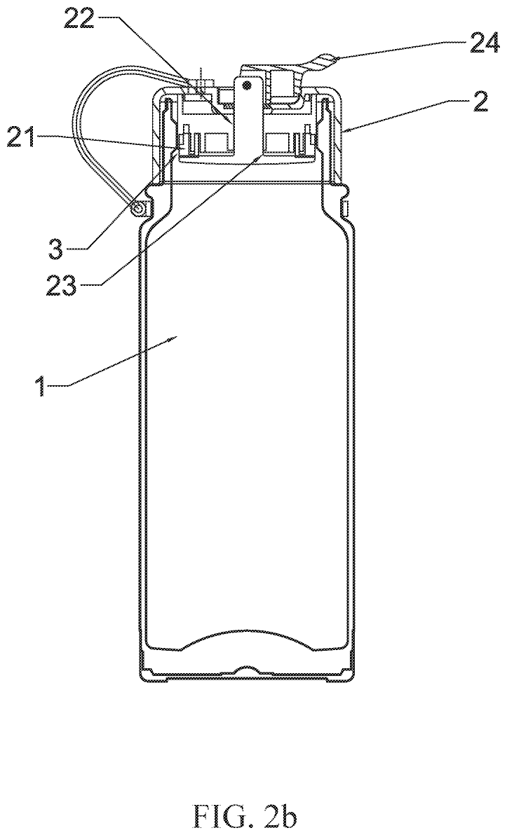

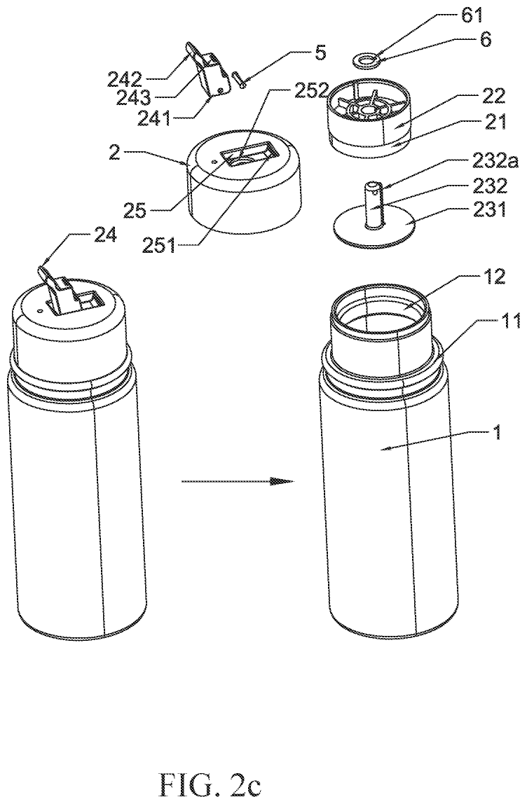

Different from the Example 1, as shown in FIGS. 2a-2c, the quick uncapping structure in this example is characterized in that, a groove 25 is formed in the outer top face of the cover; a clamping groove 251 is formed in the inner wall of the groove 25; in this example, the lever 24 is rotated around the pin shaft 5; the lower end of the lever 24 is positioned in the groove 25; and a protruding part 243 positioned between the pressing part 242 and the connecting part 241 is embedded in the clamping groove 251 to lock the lever 24 on the cover 2.

In this example, the quick uncapping structure further comprises a gasket 6 arranged in an accommodating groove 252 in the center of the groove 25; the vertical rod 232 penetrates through the center hole of the cover 2 and the gasket 6, and is connected to the connecting part 241 of the lever through the pin shaft 5; and the lever 24 can be rotated around the pin shaft 5.

In one example, as the gasket 6, the annular guide piece 22 and the elastic sealing ring 21 sleeve the vertical rod 232 in sequence from top to bottom, and the upper end of the elastic sealing ring 21 is assembled with the lower end of the annular guide piece 22, in order to achieve axial installation and positioning, a guide bar 232a is longitudinally arranged at the outer periphery of the vertical rod 232; gaps 61 are respectively formed in the through holes in the centers of the gasket 6 and the annular guide piece 22; and when the vertical rod 232 penetrates through the annular guide piece 22 and the gasket 6 for assembling, the guide bar 232a penetrates through the gap of the annular guide piece 22, the gap of the center hole of the cover 1 and the gap 61 of the gasket 6 to finish directional accurate assembling.

In this example, two ends of the connecting belt 4 are respectively connected to the outer wall of the main body 1 and the outer top face of the cover 2.

It should be noted that the foregoing description only describes the preferred embodiments and the applied technical principles of the present invention. Those skilled in the art should understand that the present invention is not limited to the specific embodiments described herein, and various obvious changes, readjustments and substitutions can be made without departing from the protection scope of the present invention. Therefore, although the present invention has been described in detail through the above embodiments, it is not limited to the above embodiments and can also include more other equivalent embodiments without departing from the concept of the present invention, and the scope of the present invention is defined by the scope of the appended claims.

What is claimed is:

1. A quick uncapping structure, comprising a cover body, the cover body comprises a cover (2), an elastic sealing ring (21), a guide rod (23) and a lever (24); the guide rod (23) comprises a supporting bottom plate (231) and a vertical rod (232), the guide rod (23) is arranged in the cover (2), and the vertical rod (232) of the guide rod penetrates through a center hole of the cover (2) to be rotationally connected with the external lever (24); the guide rod (23) is sleeved with the elastic sealing ring (21), and the bottom face of the elastic sealing ring makes contact with the supporting bottom plate (231);
the cover (2) covers a drinking opening (12) of a main body (1) accommodating liquid; the elastic sealing ring (21) and the guide rod (23) stretch into the drinking opening (12); the lever (24) drives the guide rod (23) to move upwards when being rotated to a locking state, and the elastic sealing ring (21) is extruded to deform to make contact with the inner wall of the drinking opening (12) to be in a sealed state.

2. The quick uncapping structure according to claim 1, wherein a concave elastomer deformation accommodating area (3) is arranged on the inner wall of the drinking opening (12), and when the lever (24) is rotated to the locking state, the guide rod (23) is driven to move upwards to compress the elastic sealing ring (21) to enter the elastomer deformation accommodating area (3) to be in a sealed state.

3. The quick uncapping structure according to claim 1, wherein the outer wall of the elastic sealing ring (21) is an arc-shaped face or a straight face.

4. The quick uncapping structure according to claim 1, wherein the quick uncapping structure further comprises an annular guide piece (22) arranged in the cover (2), the vertical rod (232) is sleeved with the annular guide piece (22), the upper end of the annular guide piece makes contact with the inner top face of the cover (2), and the lower end of the annular guide piece is assembled with the upper end of the elastic sealing ring (21).

5. The quick uncapping structure according to claim 4, wherein at least one first limiting part (221) is arranged on the lower end face of the annular guide piece (22), at least one second limiting part (211) is arranged on the upper end face of the elastic sealing ring (21), and the first limiting part is matched with the second limiting part (211).

6. The quick uncapping structure according to claim 4, wherein the outer wall of the annular guide piece (22) is in clearance fit with the inner wall of the drinking opening (12).

7. The quick uncapping structure according to claim 6, wherein an annular protruding part (121) is arranged on the inner wall of the drinking opening (12), and the opening guide-in section (11) is arranged on the annular protruding part (121).

8. A container comprises the quick uncapping structure of claim 1 and a main body (1) for accommodating liquid.

9. The container according to claim 8, wherein a boss (11) is arranged on the outer wall of the lower end of the drinking opening (12), and the lower end face of the cover (2) makes contact with the boss (11) in a propping abutting mode when the drinking opening (12) is covered with the cover (2).

10. The container according to claim 8, wherein the container further comprises a connecting belt (4), the two ends of the connecting belt (4) are connected to the outer wall of the main body (1) and the outer wall of the cover (2) respectively.
